(19) United States
(12) Patent Application Publication
(10) Pub. No.: US 2002/0023712 A1
(43) Pub. Date: Feb. 28, 2002

(54) Method of manufacturing a modulus stiffened hard disc

(76) Inventors: Vivek M. Sample, Murrvsville, PA (US); Neville C. Whittle, Pittsburgh, PA (US); Vincent A. Paola, Jeannette, PA (US); Richard C. Becker, Livermore, CA (US)

Correspondence Address: ALCOA INC, ALCOA TECHNICAL CENTER, 100 TECHNICAL DRIVE, ALCOA CENTER, PA, 15069-0001, US

(21) Appl. No.: 09/944,330

(22) Filed: Sep. 4, 2001

Related U.S. Application Data
(62) Division of application No. 09/481,432, filed on Jan. 12, 2000.

(51) Int. Cl. B29C 47/00

(52) U.S. Cl. 156/245

(57) ABSTRACT

The present invention is directed to a method of manufacturing and the product therefrom for stiffening polymeric hard discs through the use of a rigid medium such as an aluminum alloy for use in computer hard drives.

### RELATED APPLICATIONS

The present application claims the benefit of U.S. Provisional Application Ser. No. 60/115,679, entitled “Modulus Stiffening of Compact Discs”, filed Jan. 13, 1999.

### FIELD OF THE INVENTION

The present invention is directed to hard discs, more particularly to hard discs (“HDs”) sandwiches for use in information storing and subsequent reading and writing formed from an aluminum alloy and coated with one or more layers of polymer.

### Background of the Invention

One of the problems in the art of HD production is the ever-increasing need for tighter physical tolerances in the HDs such as flatness, internal dimensions, outside dimensions, edge shape, and other features. These tolerances are becoming more critical as computer manufacturers seek to increase the efficiency of information transfer by placing the read-write head of an information transfer device as close as possible to the HD.

Conventional blank HDs for use as computer hard drives have been made from aluminum alloys and provide a sufficiently stable platform for some environments. However, these pure aluminum alloy HDs typically do not have a completely flat read-write surface. Consequently, any warp in the aluminum HD means that the read write-head may not be able to be moved in closely thereto or else risk that the HD becomes scraped by the head, causing an all too familiar computer “crash.”

An alternative material for the production of HDs is certain polymer types, such as polycarbonates, imides, amides, and combinations thereof. HDs made from these polymers can be quickly manufactured and are commonly used in the music recording industry. One benefit of polymeric HDs is the ability to emboss information features directly into the exposed surface of the HD. The embossed information features permit rapid location of the information on the polymeric HDs. However, in many environments, polymeric HDs do not provide a stable platform because they tend to warp and creep under some conditions. Polymeric HDs are particularly susceptible to a condition known as flutter when used as hard drives. Flutter occurs when the hard drive is rotated at high speeds causing excessive vibration in the HD. Presently, computer hard drives are required to rotate at speeds of up to 10,000 revolutions per minute. Polymeric HDs cannot be used in these high-speed computers.

Therefore, this art continues to search for a rigid and stable HD platform that can be manufactured in high volume with a 100% fidelity for storage and read back.

That an invention in this field can be useful practically goes without saying since the computer field and the subsequent use of HDs in that field has exploded.

### SUMMARY OF THE INVENTION

The need for a rigid and stable HD is met by the HD of the present invention which is particularly suited for use as a computer hard drive. The HD of the present invention includes a disc-shaped substrate having a first side and a second side, wherein the substrate is sized and configured for use as a computer hard drive and a polymer layer covering at least one of the sides of the substrate. The substrate is preferably formed from aluminum or an aluminum alloy such as the 1xxx, 2xxx, 5xxx, 6xxx, and 8xxx series aluminum alloys, more preferably, the 1050, 3003, 5005, and 6013 aluminum alloys and most preferably, the 1000 and 5000 series aluminum alloys. The substrate is preferably about 0.2 to 1.0 mm thick, more preferably about 0.4 to 0.6 mm thick.

The polymer layer is formed from a polymer selected from the group consisting of an imide, an amide, a polycarbonate and combinations thereof A polycarbonate polymer is preferred. The polymer layer on the first and second sides of the substrate is about 0.01 to 0.5 mm.

The present invention further includes a method of manufacturing a hard disc comprising the steps of (1) providing a disc-shaped substrate having a first side and a second side, the substrate being sized and configured for use as a computer hard drive; (2) applying a polymer layer to at least one of the sides of the substrate to produce a polymer coated substrate; and (3) compression molding the polymer coated substrate, thereby fixing the polymer layer to the substrate. Preferably, in this method of the present invention, the substrate is made from aluminum or an aluminum alloy and the polymer is an imide, an amide, a polycarbonate or combinations thereof The compression-molding step is preferably performed at a temperature of about 150° to 400° C. at a pressure of about 1000 to 2000 psi.

A complete understanding of the invention will be obtained from the following description when taken in connection with the accompanying drawing figures wherein like reference characters identify like parts throughout.

### BRIEF DESCRIPTION OF THE DRAWINGS

FIG. 1 is plan view of the hard disc made in accordance with the present invention; and

FIG. 2 is a cross-sectional view of the hard disc shown in FIG. 1 taken along line II-II.

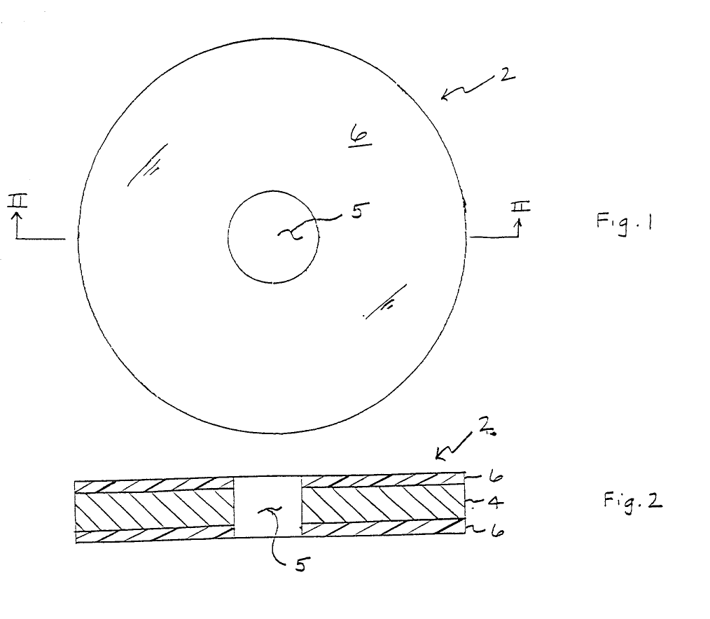

### DETAILED DESCRIPTION OF THE PREFERRED EMBODIMENTS

For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

The present invention is directed to a HD and its method of manufacture. The HD 2 of the present invention includes a substrate 4 in the form of a conventional HD, namely a thin disc with a central hole 5 therethrough. The substrate 4 is coated or clad with at least one polymer layer 6. The polymer layer 6 may be present on one or both surfaces of the substrate 4, preferably, two polymer layers are used to sandwich the substrate. The alloy can be considered to be the meat of the sandwich and the polymer to be the bread. The elastic modulus and, accordingly, the stiffness and rigidity of this combination of substrate 4 and polymer layer 6 is much greater than that of a disc formed solely of polymer.

Preferably, the substrate 4 is made from an aluminum alloy. Any of the series of alloys known by the Aluminum Association and registered thereunder could be potentially used for this stiffened alloy platform medium. Especially useful however, are the 1xxx, 3xxx, 5xxx, 6xxx, and the 8xxx, such as the Al-Li series of alloys. Preferred aluminum alloys are the 1050, 3003, 5005, and 6013 alloys. Most preferred are the 1000 and 5000 series of aluminum alloys. Aluminum alloy, of course, is not the only material suitable for forming into the substrate 4; other materials with similar strength properties could be used in place of aluminum alloy.

Other metals and their alloys from the first and second transition series in either their pure state and in combination could be used. For example, titanium would be an excellent choice; however, titanium is expensive and may cost prohibitive. The metal used in the substrate 4 preferably should not be magnetic or at least be insufficiently magnetic to avoid any interfere with the storage and retrieval of information to and from the HD 2. Other materials such as ceramics, borides, carbides, glasses, glass ceramics, and combinations thereof could be usefully employed since these materials provide a stiffer modulus than the polymers currently in use.

Any polymer such as the thermoplastics and blends thereof may be useful for the polymer layer 6. It is preferred that the polymer is of optical quality, such as the polycarbonates. This generally means that the polymer must be a pure polymer, cleanable, and stable over a temperature range of about 0° to 120° F. and have a high glass transition temperature. High glass transition temperature materials allow a wider range of coating or cladding process without adversely affecting the properties of the polymer. In particular, imides, amides, polycarbonates and mixtures thereof are useful in the present invention. In particular, preferred are the family of polycarbonates.

The HD of the present invention is preferably prepared as follows. Generally, the substrate 4 is punched out from a sheet of the aluminum alloy into circular discs as a blank. Having thus been punched, the substrate 4 is cleaned, and preferably pretreated with a conversion coating to promote adhesion of the polymer layer 6 thereto. Any pretreatment that promotes adhesion or stick-togetherness will be effective in mating the substrate to the film, coating or clad polymer material. The treated substrate 4 is coated or clad on the upper and/or lower surfaces thereof with a polymeric material. In particular, if the preferred polycarbonate is used, it is additionally preferred that the polymer is dried to a dew point prior to application to the substrate 4. Generally, it is advisable to dry the polymer prior to application onto the substrate 4, although there may be instances that the polymer may be applied the substrate 4 in a wet environment. The substrate 4 and polymer 6 are fixed together via by heat and pressure in a mold or forming apparatus. Preferably, heat is applied to raise the temperature of the HD 2 being formed to about 150° to 400° C. at a pressure of about 1000 to 2000 pounds per square inch (pi). In citing ranges included within the range are the single and multiple digits therebetween, including but not limited to decimals tenths, thousandths and therebeyond. The pressure is applied preferably for a few seconds, although more than a few seconds is not harmful when at about 250° C. The HD 2 is rapidly cooled either with a gas or liquid quench or cooling plate, preferably with a system to limit contamination such as a cooling plate. The surface of the HD 2 is a mirror image of any mold used to form the HD 2. Hence, the surface of the HD can be made substantially flat when produced in a flat mold or the surface may include a variety of pits or embossments when produced in a mold having corresponding raised or depressed areas thereon.

An alternative method of sandwiching the substrate 4 with the polymer layer 6 is to first extrude the polymer the surface of an aluminum alloy sheet to produce a laminated sheet. The laminated sheet is stamped or punched out into discs, which are subsequently further formed by in a forming apparatus such as a mold, embossing tool or hot stamping tool at the temperature, and pressure conditions stated hereinabove.

Another method of producing the HD 2 of the present invention is to spin cast the polymer material onto the punched aluminum alloy disc. This spin cast disc is likewise treated in a forming apparatus as described hereinabove.

Preferably, the substrate 4 is about 0.1 mm to 2.00 mm in thickness with a diameter suitable for conforming to HD computer disc drives. More preferably, the substrate 4 is about 0.2 to 1.0 mm thick, most preferably about 0.4 to 0.6 mm thick. The polymer layer 6 is made to conform to the substrate 4 shape and size. The polymer layer preferably is from about 0.001 mm to 1 mm thick, preferably about 0.01 to 0.5 mm thick. It is appreciated that the numbers between these ranges are included as has been stated hereinabove. The polymer layer 6 may be formed in a single layer or a plurality of sublayers. The type of polymer may be the same or different on opposing sides of the substrate 4 and may be different in the various sublayers The polymer layer 6 may be the same thickness on both sides of the substrate 4 or may be of differing thickness on opposing sides of the substrate 4. In a particularly preferred embodiment, the polymer layer 6 is present on both sides of the substrate 4 and is formed from a polycarbonate polymer.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A hard disc adapted for use in HD computer disc drives comprising:
a disc-shaped substrate having a first side and a second side, said substrate being sized and configured for use as a computer hard drive; and
a polymer layer covering at least one of said sides of said substrate.

2. The hard disc of claim 1 wherein said substrate is formed from aluminum or an aluminum alloy.

3. The hard disc of claim 2, wherein said aluminum alloy is selected from the group consisting of 1xxx, 2xxx, 5xxx, 6xxx, and 8xxx series aluminum alloys.

4. The hard disc of claim 3 wherein said aluminum alloy is selected from the group consisting of 1050, 3003, 5005, and 6013 aluminum alloys.

5. The hard disc of claim 2 wherein said aluminum alloy is selected from the group consisting of 1000 and 5000 series aluminum alloys.

6. The hard disc of claim 1 wherein said substrate is about 0.2 to 1.0 mm thick.

7. The hard disc of claim 1 wherein said substrate is about 0.4 to 0.6 mm thick.

8. The hard disc of claim 1 wherein said polymer layer is formed from a polymer selected from the group consisting of an imide, an amide, a polycarbonate and combinations thereof.

9. The hard disc of claim 1 wherein said polymer layer is formed from a polycarbonate polymer.

10. The hard disc of claim 1 wherein the thickness of the polymer layer on said first side of said substrate is 0.01 to 0.5 mm.

11. The hard disc of claim 1 wherein the thickness of the polymer layer on said second side of said substrate is 0.01 to 0.5 mm.

12. A method of manufacturing a hard disc comprising the steps of:
providing a disc-shaped substrate having a first side and a second side, the substrate being sized and configured for use as a computer hard drive;
applying a polymer layer to at least one of the sides of the substrate to produce a polymer coated substrate; and
compression molding the polymer coated substrate, thereby fixing said polymer layer to said substrate.

13. The method as claimed in claim 11 wherein the substrate is made from aluminum or an aluminum alloy.

14. The method as claimed in claim 11 wherein the polymer is selected from the group consisting of an imide, an amide, a polycarbonate and combinations thereof.

15. The method as claimed in claim 11 wherein said compression molding step is performed at a temperature of about 150° to 400° C. at a pressure of about 1000 to 2000 psi.
